(19) United States
(12) Patent Application Publication
(10) Pub. No.: US 2013/0334901 A1
(43) Pub. Date: Dec. 19, 2013

(54) IRONLESS ELECTRICAL MACHINES WITH INTERNAL WATER COOLED WINDING BETWEEN TWO MAGNET ROWS

(71) Applicant: Alexei Stadnik, Beverly Hills, CA (US)

(72) Inventor: Alexei Stadnik, Beverly Hills, CA (US)

(21) Appl. No.: 13/261,684

(22) PCT Filed: Dec. 22, 2011
(86) PCT No.: PCT/US11/66884

§ 371 Date: Jun. 27, 2013

Related U.S. Application Data
(60) Provisional application No. 61/460,270, filed on Dec. 28, 2010.

(51) Int. Cl. H02K 9/19

(52) U.S. Cl. CPC H02K 9/19
USPC 310/12.25; 310/54

(57) ABSTRACT

The invention provides ironless electrical machines with internal water cooled winding between two magnet rows. The winding with internal water cooling has very high heat dissipation and continuous force. In the invented construction (the water cooling plate inside the winding between two rows of magnets), Eddy currents are low due to opposite magnetization direction of the magnets in the rows.

I, Alexei Stadnik, claim priority of provisional application No. 61/460,270

### BACKGROUND OF THE INVENTION

The design of ironless electrical machine with winding between two magnet rows is well known. In the traditional construction, the magnetization direction of the magnets in the rows is unidirectional and changes along the moving direction (A Transfer-Positioning System with Linear DC Motor by Morimasa KAJIOKA, Susumu TONI, Masaya WATADA and Daiki EBIHARA—Conference Record of the 2000 IEEE Industry Applications Conference: Thirty-Fifth Annual Meeting and World Conference on Industrial Applications of Electrical Energy). This type of electrical machines has many benefits comparing the electrical machines with one row of magnets but also has problem concerning the heat dissipation in the winding.

For electrical machines with winding between two magnet rows, the problem of heat dissipation is well known. For this construction, the natural cooling is low. To increase the electrical machine heat dissipation, the water cooling may be used. One of the best ways to carry out the heat is placing the water cooling plate inside the winding. The water cooling plate is usually made of aluminum, copper or other conductive materials. Therefore, when winding moves between two magnet rows in the traditional electrical machine, Eddy currents occur in the water cooling plate.

The invented construction of ironless electrical machines with internal water cooled winding between two matmet rows allows minimizing Eddy currents in the water cooling plate. The magnetization direction of the magnets in the rows is opposite. Due to this, the direction of magnetic field at the center plane between magnets is not perpendicular to the moving direction. Therefore, the Eddy current losses for this construction are much less than for traditional design of ironless electrical machine with winding between two magnet rows.

### DESCRIPTION OF THE FIGURES

FIG. 1.1—Traditional construction of the linear U-shape ironless electrical machine.

FIG. 1.2—Invented linear U-shape ironless electrical machine construction, winding with internal water cooling.

FIG. 2.1—Traditional construction of rotary radial ironless electrical machine.

FIG. 2.2—Invented rotary radial ironless electrical machine construction, winding with internal water cooling.

FIG. 3.1—Traditional construction of rotary axial ironless electrical machine.

FIG. 3.2—Invented rotary axial ironless electrical machine construction, winding with internal water cooling.

### DRAWINGS—REFERENCE NUMERALS

10—Forcer, Traditional linear U-shape ironless electrical machine.

12—Coils, linear U-shape ironless electrical machine

14—Base, linear U-shape ironless electrical machine

16—Water cooling plate, linear U-shape ironless electrical machine, winding with internal water cooling

18—Magnet track, traditional linear U-shape ironless electrical machine

20—Frame, linear U-shape ironless electrical machine

22—Magnets, linear U-shape ironless electrical machine

24—Forcer, linear U-shape ironless electrical machine, winding with internal water cooling

26—Aluminum lamination, linear U-shape ironless electrical machine, winding with internal water cooling

28—Magnet track, linear U-shape ironless electrical machine, winding with internal water cooling

30—Water channels, linear U-shape ironless electrical machine, winding with internal water cooling

40—Stator, traditional rotary radial ironless electrical machine with winding between two magnet rows

42—Coils, rotary radial ironless electrical machine with winding between two magnet rows

44—Base, rotary radial ironless electrical machine with winding between two magnet rows

46—Aluminum lamination, rotary radial ironless electrical machine, winding with internal water cooling between two magnet rows

48—Rotor, traditional rotary radial ironless electrical machine with winding between two magnet rows

50—Frame, rotary radial ironless electrical machine with winding between two magnet rows

52—Magnets, rotary radial ironless electrical machine with winding between two magnet rows

54—Stator, rotary radial ironless electrical machine, winding with internal water cooling between two magnet rows

56—Water cooling system, rotary radial ironless electrical machine, winding with internal water cooling between two magnet rows

58—Rotor, rotary radial ironless electrical machine, winding with internal water cooling between two magnet rows

60—Water channels, rotary radial ironless electrical machine, winding with internal water cooling between two magnet rows

70—Stator, traditional rotary axial ironless electrical machine with winding between two magnet rows

72—Coils, rotary axial ironless electrical machine with winding between two magnet rows

74—Base, rotary axial ironless electrical machine with winding between two magnet rows

76—Aluminum lamination, rotary axial ironless electrical machine, winding with internal water cooling between two magnet rows

78—Rotor, traditional rotary axial ironless electrical machine with winding between two magnet rows

80—Frame, rotary axial ironless electrical machine with winding between two magnet rows

82—Magnets, rotary axial ironless electrical machine with winding between two magnet rows

84—Stator, rotary axial ironless electrical machine, winding with internal water cooling between two magnet rows

86—Water cooling system, rotary axial ironless electrical machine, winding with internal water cooling between two magnet rows

88—Rotor, rotary axial ironless electrical machine, winding with internal water cooling between two magnet rows

90—Water channels, rotary axial ironless electrical machine, winding with internal water cooling between two magnet rows

### DESCRIPTION OF THE PREFERRED EMBODIMENT

U-Shape Linear Ironless Electrical Machine, Winding with Internal Water Cooling.

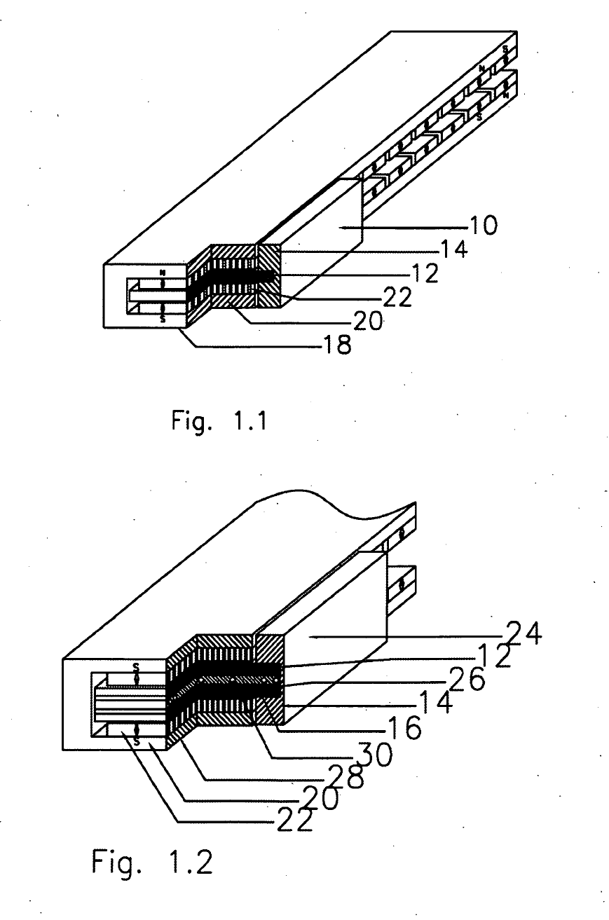

The traditional construction of the U-shape ironless electrical machine is shown on FIG. 1.1. Forcer 10 consists of coils 12 mounted to the base 14. Magnet track 18 consists of frame 20 and magnets 22 mounted to the frame. The magnetization of magnets in the two rows is unidirectional.

The invented U-shape ironless electrical machine construction with internal water cooled winding includes forcer 24 consisted of coils 12 mounted to the base 14, ironless lamination 26 and water cooling plate 16 with water channels 30 (FIG. 1.2). Magnet track 28 consists of frame 20 and magnets 22 mounted to the frame. The magnetization direction of the magnets in the rows is opposite.

Due to opposite direction of magnetization, the direction of magnetic field at the center plane between magnets is not perpendicular to the moving direction. Therefore, the Eddy current losses for this construction are much less than for traditional design of ironless electrical machine with winding and cooling plate between two magnet rows. To minimize Eddy current losses, the optimization of lamination and coils thicknesses is to be made.

Rotary Radial Ironless Electrical Machine, Winding with Internal Water Cooling Between Two Magnet Rows.

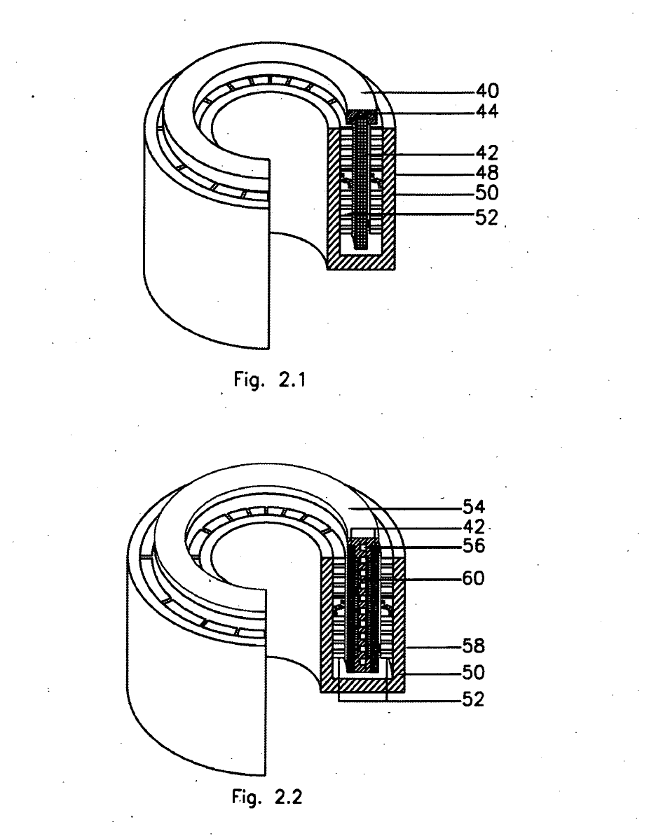

The traditional construction of the rotary radial ironless electrical machine with winding between two magnet rows is shown on FIG. 2.1. Stator 40 consists of coils 42 mounted to the base 44. Rotor 48 consists of frame 50 and magnets 52 mounted to the frame. The magnetization of magnets in the two rows is unidirectional.

The invented rotary radial ironless electrical machine construction with internal water cooled winding includes stator 54 consisted of coils 42 mounted to the water cooling system 56 with water channels 60 and ironless lamination 46 (FIG. 2.2). Rotor 58 consists of frame 50 and magnets 52 mounted to the frame. The magnetization direction of the magnets in the rows is opposite.

Due to opposite direction of magnetization, the direction of magnetic field at the center between magnets is not perpendicular to the moving direction. Therefore, the Eddy current losses for this construction are much less than for traditional design of ironless electrical machine with winding and cooling plate between two magnet rows. To minimize Eddy current losses, the optimization of lamination and coils thicknesses is to be made.

Rotary Axial Ironless Electrical Machine, Winding with Internal Water Cooling Between Two Magnet Rows.

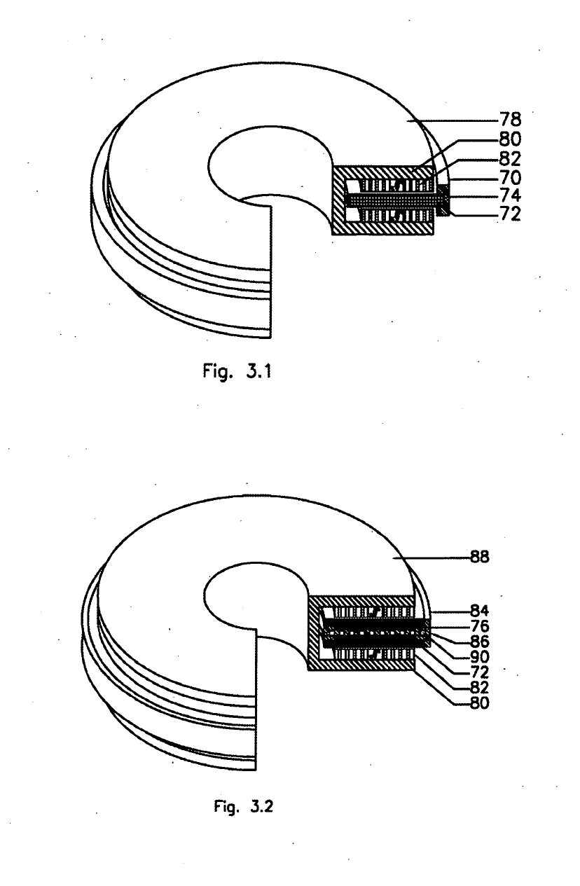

The traditional construction of the rotary radial ironless electrical machine with winding between two magnet rows is shown on FIG. 3.1. Stator 70 consists of coils 72 mounted to the base 74. Rotor 78 consists of frame 80 and magnets 82 mounted to the frame. The magnetization of magnets in the two rows is unidirectional.

The invented rotary radial ironless electrical machine construction with internal water cooled winding includes stator 84 consisted of coils 72 mounted to the water cooling system 86 with water channels 90 and ironless lamination 76 (FIG. 3.2). Rotor 88 consists of frame 80 and magnets 82 mounted to the frame. The magnetization direction of the magnets in the rows is opposite.

Due to opposite direction of magnetization, the direction of magnetic field at the center between magnets is not perpendicular to the moving direction. Therefore, the Eddy current losses for this construction are much less than for conventional design of ironless'electrical machine with winding and cooling plate between two magnet rows. To minimize Eddy current losses, the optimization of lamination and coils thicknesses is to be made.

1. An ironless electrical machine, comprising:
a) internal water cooled winding between two magnet rows,
b) magnets in the rows having opposite direction of magnetization.

2. A linear U-shape ironless electrical machines, comprising:
a) internal water cooled winding between two magnet rows, forcer having coils, internal water cooling system,
b) magnet track having a frame and magnets mounted to the frame in two rows, the magnets in the rows have opposite direction of magnetization.

3. A rotary radial ironless electrical machines, comprising:
a) internal water cooled winding between two magnet rows, stator having coils, internal water cooling system,
b) rotor having of frame and magnets mounted to the frame in two rows, the magnets in the rows have opposite direction of magnetization.

4. A rotary axial ironless electrical machines, comprising:
a) internal water cooled winding between two magnet rows, stator having coils, internal water cooling system,
b) rotor having of frame and magnets mounted to the frame in two rows, the magnets in the rows have opposite direction of magnetization.
